(19) United States
(12) Patent Application Publication
(10) Pub. No.: US 2008/0169718 A1
(43) Pub. Date: Jul. 17, 2008

(54) Reluctance Motor

(75) Inventors: Erich Bott, Hollstadt (DE); Matthias Braun, Weichtungen (DE); Holger Schunk, Lendershausen (DE); Rolf Vollmer, Gersfeld (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, Munchen (DE)

(21) Appl. No.: 11/911,024

(22) PCT Filed: Mar. 31, 2006
(86) PCT No.: PCT/EP2006/061248

§ 371 Date: Oct. 9, 2007

(30) Foreign Application Priority Data
Apr. 8, 2005 (DE) 10 2005 016 257.6

(51) Int. Cl. H02K 21/44

(52) U.S. Cl. 310/155

(57) ABSTRACT

A reluctance motor comprises a stator (2) and a rotor (4). The stator (4) consists of a ferromagnetic but not permanent-magnetic material and has stator teeth (6) that are radially directed towards the rotor (4). Two tangentially adjacent stator teeth (6) each define between them one respective stator slot (7) in which a part of a stator winding (8) is arranged. Permanent magnets (10) are arranged on the stator (2) and emit permanent magnetic fields. The permanent magnets (10) are arranged tangentially in the area of the stator slots (7) and their magnetic fields are radially oriented in the same direction. The permanent magnets are associated with flux guiding elements (12) which deflect the permanent magnetic fields emitted by the permanent magnets (10) in such a manner to the stator teeth (6) that the permanent magnetic fields, based on the tangential position, are oriented in the opposite direction relative to each other in the area of the stator teeth (6) and in the area of the stator slots (7).

The present invention relates to a reluctance motor having a stator and a rotor,
with the stator being composed of a material which is ferromagnetic but is not permanent magnetic, and having stator teeth which point radially towards the rotor,
with in each case two tangentially adjacent stator teeth each forming a stator slot between them, in each of which a part of a stator winding is arranged, and
with permanent magnets, from which permanent-magnet fields originate, being arranged on the stator.

Conventional three-phase synchronous servomotors operate on the principle that the winding is introduced into the stator and the excitation magnets or field windings are introduced into the rotor. The magnetic fields produced by the stator and the rotor interact with one another, and thus produce a torque.

A further possible way to design a three-phase motor is to use a conventional three-phase winding in the stator, to introduce permanent magnets additionally into the air gap between the stator and the rotor, and to design the rotor as a reluctance profile. A motor such as this is described, for example, in DE 197 43 380 C1.

The motor which is known from the prior art offers a high torque as well as a good k_{T} value even at low rotation speeds, in comparison to a conventional motor.

The introduction of the permanent magnets into the air gap has constructional disadvantages, however. On the one hand, the effective magnetic air gap—in contrast to the mechanical air gap—is relatively large because of the permanent magnets that are introduced. This results in a weaker stator field acting on the rotor, and thus in weaker coupling between the driving component (the stator) and the driven component (the rotor). This therefore results in less torque being produced, in comparison to a machine, which otherwise remains unchanged, with a smaller magnetic air gap.

A further disadvantage is the large amount of permanent-magnet material required, since permanent-magnet material is relatively costly.

The magnets must also be relatively thick, in order to generate a powerful permanent-magnet field for providing or transmitting force. However, the requirement for great thickness is contrary to the desire to choose the effective magnetic air gap between the stator and rotor to be as small as possible.

The object of the present invention is to modify the known reluctance motor such that it is possible to achieve a small effective magnetic air gap while nevertheless retaining the permanent magnets.

In the case of a reluctance motor of the type mentioned initially, the object is achieved
in that the permanent magnets are arranged tangentially in the area of the stator slots,
in that the permanent magnets are magnetized in the same sense in the radial direction, and
in that the permanent magnets have associated flux guide elements, by means of which the permanent-magnet fields originating from the permanent magnets are deflected into the stator teeth such that the permanent-magnet fields are directed in opposite senses with respect to one another, with respect to the tangential position, on the one hand in the area of the stator teeth, and on the other hand, in the area of the stator slots.

The stator teeth have a tooth clearance from the rotor in the radial direction, and the permanent magnets have a magnet clearance.

Since the magnet clearance is at least as great as the tooth clearance, the effective magnetic air gap can be minimized.

Further advantages and details will become evident from the following description of one exemplary embodiment, in conjunction with the drawings, in which, illustrated in an outline form:

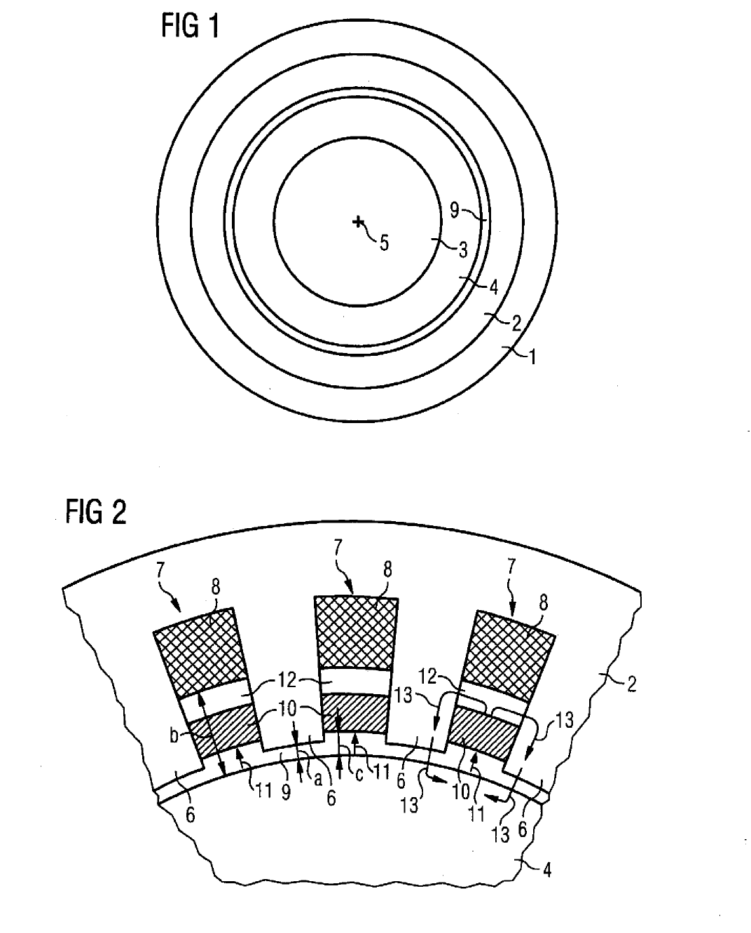

FIG. 1 shows a section through a reluctance motor, and

FIG. 2 shows a detail according to the invention from FIG. 1.

As shown in FIG. 1, a reluctance motor has a housing 1 in which a stator 2 is arranged. By way of example, the housing 1 is composed of steel. The stator 2 is composed of a material which is ferromagnetic but is not permanent-magnetic. By way of example, it may be formed from iron laminates. Furthermore, the reluctance motor has a rotating body 3 on which a rotor 4 is arranged. The rotating body 3 is mounted in the housing 1 such that the rotating body 3, and the rotor 4 together with it, can rotate about a rotation axis 5.

As shown in FIG. 2, the stator 2 has stator teeth 6 which point radially towards the rotor 4, that is to say in the direction of the rotation axis 5 and away from the rotation axis 5. Two tangentially adjacent stator teeth 6 each form a stator slot 7 between them. A part of a stator winding 8 is arranged in each of the stator slots 7.

The stator teeth 6 have a tooth clearance a from the rotor 4 in the radial direction. This tooth clearance a corresponds to the mechanical air gap 9 of the reluctance motor which, at the same time, and in contrast to the known reluctance motor, is also the effective magnetic air gap 9.

As shown in FIG. 2, the stator winding 8 has a winding clearance b from the rotor 4 in the radial direction, with this clearance b being greater than the tooth clearance a. The stator winding 8 therefore does not fill the stator slots 7. It is therefore possible to insert permanent magnets 10 into the stator slots 7, from which permanent magnets—trivially—permanent-magnet fields originate. Because the permanent magnets 10 have been inserted into the stator slots 7, the permanent magnets 10 are therefore arranged on the stator 2. This fact means that they are arranged tangentially further, that is to say seen in the circumferential direction around the rotation axis 5, in the area of the stator slots 7.

The permanent magnets 10 are magnetized in the same sense in the radial direction. This is indicated by arrows 11 in FIG. 2, which all point in the same direction seen in the radial direction, that is to say they all point radially outwards.

In order nevertheless to produce permanent-magnet fields which are dependent on the location, seen in the tangential direction, the permanent magnets 10 have associated flux guide elements 12. The flux guide elements 12 deflect the permanent-magnet fields into the stator teeth 6. In this case, the permanent-magnet fields are deflected such that they are in the opposite sense to the permanent fields in the area of the stator slots 7 in the area of the stator teeth 6. This is illustrated in FIG. 2 for one of the permanent magnets 10, by showing the corresponding magnetic lines of force 13.

The flux guide elements 12 are composed of a material which is ferromagnetic but not permanent magnetic. The material may be the same as that from which the stator 2 is also made.

The permanent magnets 10 have a magnet clearance c from the rotor 4 in the radial direction. The magnet clearance c is preferably at least as great as the tooth clearance a.

The reluctance motor according to the invention therefore makes it possible to make the effective magnetic air gap just as small as the actual mechanical air gap 9. This reduction in the gap compensates for, or more than compensates for, the reduction in the magnetic flux which is caused by the permanent magnets 10 being separated from one another, seen in the tangential direction. Furthermore, this requires only half the amount of magnetic material as that required for the reluctance motor according to the prior art. In addition, it is easier to fit the permanent magnets 10 to the stator 2, and the entire manufacturing process for the stator 2 is simpler, as well. In particular, the air gap 9 can be manufactured more exactly because the magnet clearance c is at least as great as the tooth clearance a.

1.-2. (canceled)

3. A reluctance motor, comprising:
a rotor;
a stator composed of a material which is ferromagnetic but not permanent magnetic, said stator having stator teeth which point radially towards the rotor, wherein each two tangentially adjacent stator teeth define a stator slot between them for acceptance of part of a stator winding;
permanent magnets which are arranged in the stator slots and from which permanent-magnet fields originate, wherein the permanent magnets are magnetized in a same sense in a radial direction; and
flux guide elements associated to the permanent magnets for deflecting the permanent-magnet fields into the stator teeth such that the permanent-magnet fields in an area of the stator teeth are directed in opposite sense to the permanent-magnetic fields in an area of the stator slots.

4. The reluctance motor of claim 3, wherein the stator teeth have a tooth clearance from the rotor in the radial direction, and the permanent magnets have a magnet clearance from the rotor in the radial direction, wherein the magnet clearance is at least as great as the tooth clearance.

5. The reluctance motor of claim 3, wherein the permanent magnets are arranged in the radial direction between the stator windings and the rotor.
